(19) United States
(12) Patent Application Publication
(10) Pub. No.: US 2008/0008141 A1
(43) Pub. Date: Jan. 10, 2008

(54) Methods and apparatus for providing a virtualization system for multiple media access control connections of a wireless communication platform

(76) Inventors: Izoslav Tchigevsky, Kiryat Haim (IL); Boris Ginzburg, Haifa (IL)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/481,697

(22) Filed: Jul. 5, 2006

(51) Int. Cl. H04Q 7/24

(52) U.S. Cl. 370/338

(57) ABSTRACT

Embodiments of methods and apparatus for providing a virtualization system for multiple media access control connections of a wireless communication platform are generally described herein. Other embodiments may be described and claimed.

### TECHNICAL FIELD

The present disclosure relates generally to wireless communication systems, and more particularly, to methods and apparatus for providing a virtualization system for multiple media access control connections of a wireless communication platform.

### BACKGROUND

As wireless communication becomes more and more popular at offices, homes, schools, etc., different wireless technologies and applications may work in tandem to meet the demand for computing and communications at anytime and/or anywhere. For example, a variety and/or plurality of wireless communication networks may co-exist to provide a wireless environment with more computing and/or communication capability, greater mobility, and/or eventually seamless roaming.

In particular, wireless personal area networks (WPANs) may offer fast, short-distance connectivity within a relatively small space such as an office workspace or a room within a home. Wireless local area networks (WLANs) may provide broader range than WPANs within office buildings, homes, schools, etc. Wireless metropolitan area networks (WMANs) may cover a greater distance than WLANs by connecting, for example, buildings to one another over a broader geographic area. Wireless wide area networks (WWANs) may provide the broadest range as such networks are widely deployed in cellular infrastructure. Although each of the above-mentioned wireless communication networks may support different usages, co-existence among these networks may provide a more robust environment with anytime and anywhere connectivity.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example wireless local area network.

FIG. 3 is a block diagram representation of an example virtualization system of a wireless communication platform.

FIG. 4 depicts one manner in which the example virtualization system of FIG. 3 may be configured.

FIG. 5 depicts one manner in which an example network physical driver of the example virtualization system of FIG. 2 may be configured.

FIG. 6 depicts one manner in which an example media access control (MAC) coordination device of the virtualization system of FIG. 2 may be configured.

FIG. 7 is a block diagram representation of an example processor system that may be used to implement an example wireless communication platform of FIG. 2.

### DETAILED DESCRIPTION

In general, methods and apparatus for providing a virtualization system for multiple media access control (MAC) connections of a wireless communication platform are described herein. The methods and apparatus described herein are not limited in this regard.

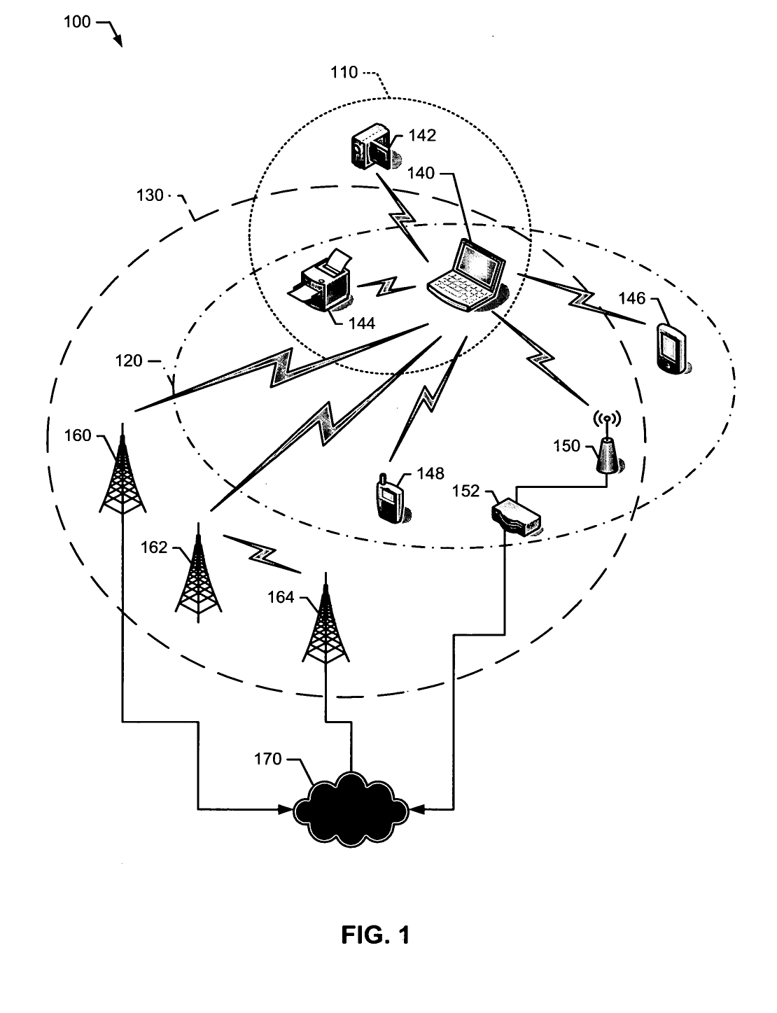

Referring to FIG. 1, an example wireless communication system 100 may include one or more wireless communication networks, generally shown as 110, 120, and 130. In particular, the wireless communication system 100 may include a wireless personal area network (WPAN) 110, a wireless local area network (WLAN) 120, and a wireless metropolitan area network (WMAN) 130. Although FIG. 1 depicts three wireless communication networks, the wireless communication system 100 may include additional or fewer wireless communication networks. For example, the wireless communication networks 100 may include additional WPANs, WLANs, and/or WMANs. The methods and apparatus described herein are not limited in this regard.

The wireless communication system 100 may also include one or more subscriber stations, generally shown as 140, 142, 144, 146, and 148. For example, the subscriber stations 140, 142, 144, 146, and 148 may include wireless electronic devices such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices. Although FIG. 1 depicts five subscriber stations, the wireless communication system 100 may include more or less subscriber stations.

The subscriber stations 140, 142, 144, 146, and 148 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation (e.g., orthogonal frequency-division multiple access (OFDMA)), multi-carrier modulation (MDM), and/or other suitable modulation techniques to communicate via wireless links. In one example, the laptop computer 140 may operate in accordance with suitable wireless communication protocols that require very low power such as Bluetooth®, ultra-wide band (UWB), and/or radio frequency identification (RFID) to implement the WPAN 110. In particular, the laptop computer 140 may communicate with devices associated with the WPAN 110 such as the video camera 142 and/or the printer 144 via wireless links.

In another example, the laptop computer 140 may use direct sequence spread spectrum (DSSS) modulation and/or frequency hopping spread spectrum (FHSS) modulation to implement the WLAN 120 (e.g., the 802.11 family of standards developed by the Institute of Electrical and Electronic Engineers (WEEE) and/or variations and evolutions of these standards). For example, the laptop computer 140 may communicate with devices associated with the WLAN 120 such as the printer 144, the handheld computer 146 and/or the smart phone 148 via wireless links. The laptop computer 140 may also communicate with an access point (AP) 150 via a wireless link. The AP 150 may be operatively coupled to a router 152 as described in further detail below. Alternatively, the AP 150 and the router 152 may be integrated into a single device (e.g., a wireless router).

The laptop computer 140 may use OFDM modulation to transmit large amounts of digital data by splitting a radio frequency signal into multiple small sub-signals, which in turn, are transmitted simultaneously at different frequencies. In particular, the laptop computer 140 may use OFDM modulation to implement the WMAN 130. For example, the laptop computer 140 may operate in accordance with the 802.16 family of standards developed by IEEE to provide for fixed, portable, and/or mobile broadband wireless access (BWA) networks (e.g., the IEEE std. 802.16-2004 (published Sep. 18, 2004), the IEEE std. 802.16e (published Feb. 28, 2006), the IEEE std. 802.16f (published Dec. 1, 2005), etc.) to communicate with base stations, generally shown as 160, 162, and 164, via wireless link(s).

Although some of the above examples are described above with respect to standards developed by IEEE, the methods and apparatus disclosed herein are readily applicable to many specifications and/or standards developed by other special interest groups and/or standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), etc.). The methods and apparatus described herein are not limited in this regard.

The WLAN 120 and WMAN 130 may be operatively coupled to a common public or private network 170 such as the Internet, a telephone network (e.g., public switched telephone network (PSTN)), a local area network (LAN), a cable network, and/or another wireless network via connection to an Ethernet, a digital subscriber line (DSL), a telephone line, a coaxial cable, and/or any wireless connection, etc. In one example, the WLAN 120 may be operatively coupled to the common public or private network 170 via the AP 150 and/or the router 152. In another example, the WMAN 130 may be operatively coupled to the common public or private network 170 via the base station(s) 160, 162, and/or 164.

The wireless communication system 100 may include other suitable wireless communication networks. For example, the wireless communication system 100 may include a wireless wide area network (WWAN) (not shown). The laptop computer 140 may operate in accordance with other wireless communication protocols to support a WWAN. In particular, these wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, 3GPP technology, standards based on these technologies, variations and evolutions of these standards, and/or other suitable wireless communication standards. Although FIG. 1 depicts a WPAN, a WLAN, and a WMAN, the wireless communication system 100 may include other combinations of WPANs, WLANs, WMANs, and/or WWANs. The methods and apparatus described herein are not limited in this regard.

The wireless communication system 100 may include other WPAN, WLAN, WMAN, and/or WWAN devices (not shown) such as network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

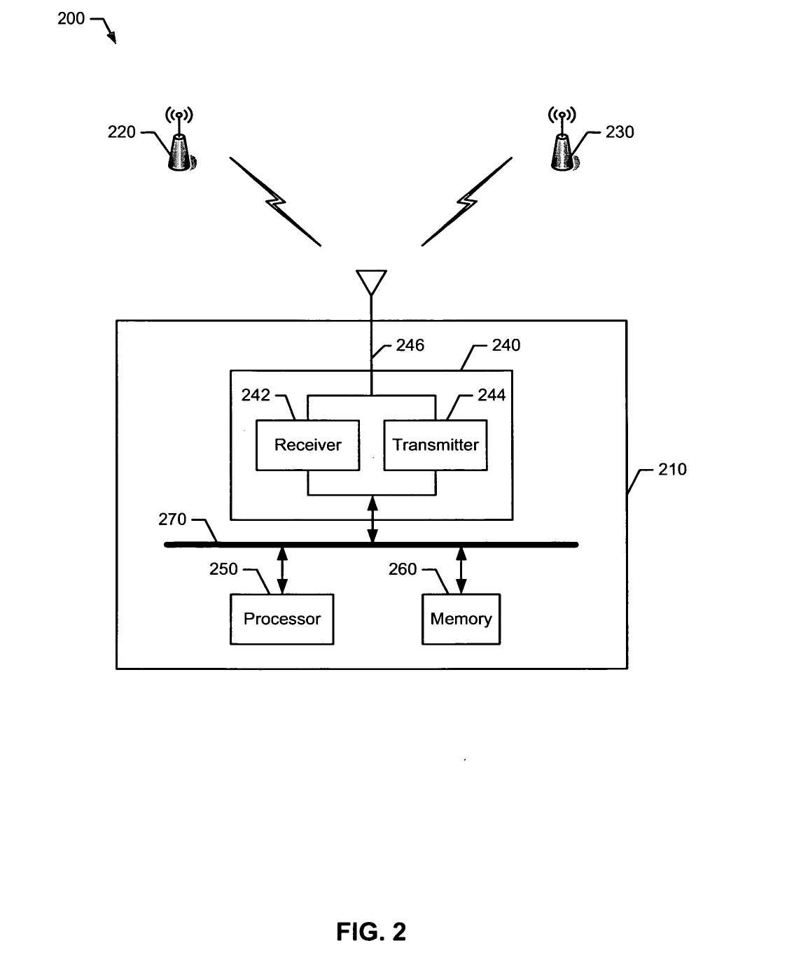

In the example of FIG. 2, a wireless communication network 200 may include a subscriber station 210 and one or more access points, generally shown as 220 and 230. For example, the wireless communication network 200 may be a WLAN. Although FIG. 2 depicts a WLAN, the methods and apparatus described herein are readily applicable to other types of wireless communication networks. Further, while FIG. 2 depicts a single subscriber station, the wireless communication network 200 may include additional subscriber stations.

In general, the subscriber station 210 may be one of the wireless electronic devices mentioned above in connection with FIG. 1 or any combination thereof. The subscriber station 210 may include a network interface device (NID) 240, a processor 250, and a memory 260. The NID 240, the processor 250, and the memory 260 may be operatively coupled to each other via a bus 270. While FIG. 2 depicts components of the subscriber station 210 coupling to each other via the bus 270, these components may be operatively coupled to each other via other suitable direct or indirect connections (e.g., a point-to-point connection or a point-to-multiple point connection).

The NID 240 may include a receiver 242, a transmitter 244, and an antenna 246. For example, the NID 240 may be a network interface card. The subscriber station 210 may receive and/or transmit data via the receiver 242 and the transmitter 244, respectively. The antenna 246 may include one or more directional or omni-directional antennas such as dipole antennas, monopole antennas, patch antennas, loop antennas, microstrip antennas, and/or other types of antennas suitable for transmission of radio frequency (RF) signals. Although FIG. 2 depicts a single antenna, the subscriber station 210 may include additional antennas. For example, the subscriber station 210 may include a plurality of antennas to implement a multiple-input-multiple-output (MIMO) system.

Although the components shown in FIG. 2 are depicted as separate blocks within the subscriber station 210, the functions performed by some of these blocks may be integrated within a single semiconductor circuit or may be implemented using two or more separate integrated circuits. For example, although the receiver 242 and the transmitter 244 are depicted as separate blocks within the NID 240, the receiver 242 may be integrated into the transmitter 244 (e.g., a transceiver).

The access points 220 and 230 may be associated with the same wireless communication network or different wireless communication networks. As described in detail below, the subscriber station 210 may be connected to two or more wireless communication networks simultaneously or concurrently. Although FIG. 2 depicts one or more basic service set (BSS) networks, the methods and apparatus described herein are readily applicable to other suitable networks such as an independent basic service set (IBSS) network. The methods and apparatus described herein are not limited in this regard.

To connect multiple virtual machines on the same platform to wired communication networks, a network junction device (e.g., a bridge, a hub, a switch, and/or a gateway) may be used. As a result, each virtual machine may be connected to a wired communication network through emulation of a network junction device such as a virtual bridge.

However, a virtual bridge may not be suitable to connect multiple virtual machines on the same platform to wireless communication networks. In one example, access points operating in accordance with the IEEE 802.11 family of standards may not expect more than one subscriber station on the other end of a wireless connection or more than one MAC address to redirect to the subscriber station. In another example, a virtual bridge may require isolation of the operating system from the wireless connection, which may prevent selection of connection profile and/or access point, overview of wireless signal strength, adjustment of security settings for the wireless connection, etc. Further, a virtual bridge may not allow each virtual machine to communicate with network infrastructure on the MAC layer to enforce security and/or traffic priority policies for different virtual machines as needed in, for example, a corporate environment. Accordingly, the methods and apparatus described herein may provide a virtualization system for multiple MAC connections of a wireless communication platform. The methods and apparatus described herein are not limited in this regard.

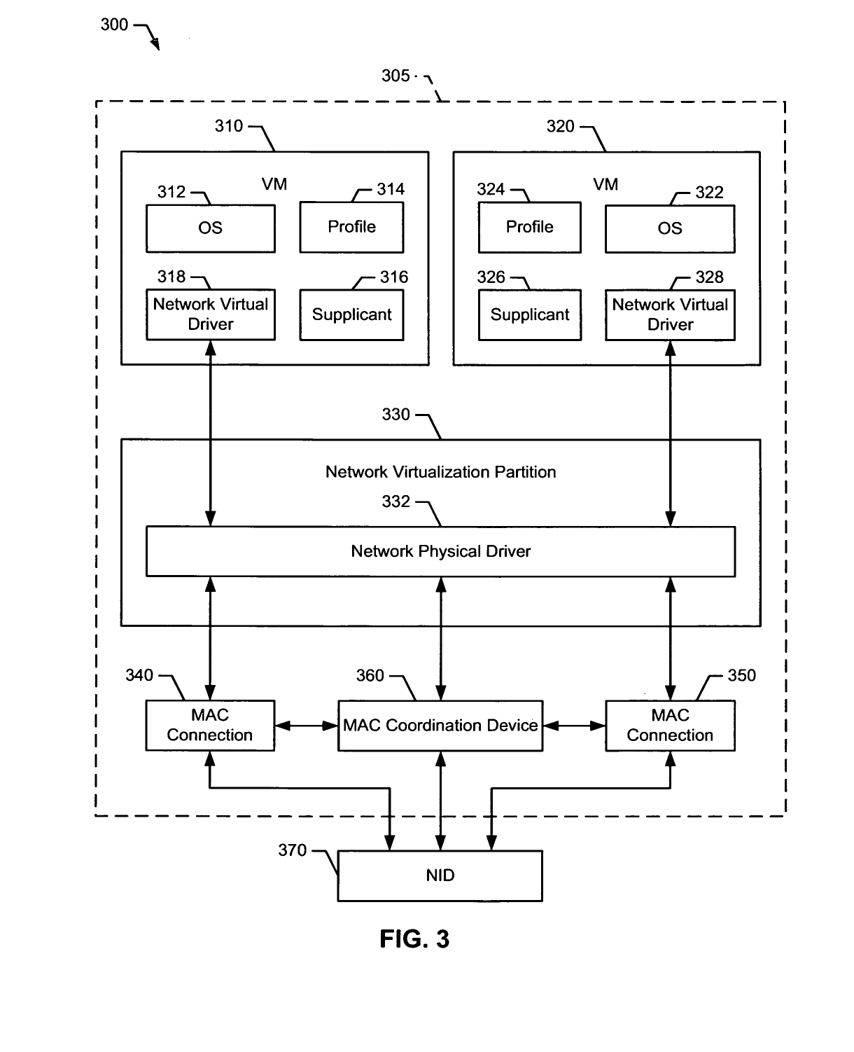

In the example of FIG. 3, a wireless communication platform 300 may include a virtualization system 305. The wireless communication platform 300 may be implemented in a subscriber station (e.g., the subscriber station 210 of FIG. 2). The virtualization system 305 may include a plurality of virtual machines (VM), generally shown as 310 and 320. Although FIG. 3 depicts two VMs, the virtualization system 300 may include additional VMs. The VMs 310 and 320 may operate on different operating systems (OS), generally shown as 312 and 322, respectively. In particular, the VM 310 may operate on the OS 312 whereas the VM 320 may operate on the OS 322.

Each of the VMs 310 and 320 may include a profile, generally shown as 314 and 324, respectively. In general, the profiles 314 and 324 may indicate settings for the wireless communication platform 300 to connect with different wireless communication networks. In one example, the profile 314 may provide settings for the wireless communication platform 300 to connect to a first wireless communication network (e.g., a personal network) whereas the profile 324 may provide settings for the wireless communication platform to connection to a second wireless communication network (e.g., an office network). In another example, the profile 314 may provide settings for the wireless communication platform 300 to connect to a WLAN for full-time employees where as the profile 324 may provide settings for the wireless communication platform 300 to connect to a WLAN for guests.

Each of the VMs 310 and 320 may also include a supplicant, generally shown as 316 and 326, respectively. In general, the supplicants 316 and 326 may communicate with an authenticator to establish authentication and authorization for a connection. Referring back to FIG. 2, for example, each of the access points 220 and 230 may be associated with an authenticator (not shown). In particular, the authenticators may be located within the access points 220 and 230. In addition or alternatively, the authenticators may be operatively coupled to the access points 220 and 230.

Turning back to FIG. 3, each of the VMs 310 and 320 may include a network virtual driver, generally shown as 318 and 328, respectively. In general, the network virtual drivers 318 and 328 may emulate functions of a network physical driver (e.g., the network physical driver 332 described below) to the OS 312 and 322, respectively. The network virtual drivers 318 and 328 may forward application programming interface (API) calls from the OS 312 and 322, respectively, to the network physical driver 332. The network virtual drivers 318 and 328 may also receive responses and/or notifications from the network physical driver 332.

The virtual drivers 318 and 328 may be operatively coupled to a network virtualization partition 330, which may include the network physical driver 332. For example, the network virtualization partition 330 may be a virtual machine or a virtual machine monitor. In general, the network virtualization partition 330 may transfer API calls between the network virtual drivers 318 and 328 and the network physical driver 332. The network physical driver 332 may serve as an interface between hardware (e.g., a network interface card) and the VMs 310 and 320, respectively.

To enforce security and/or traffic priority for the VMs 310 and 320 via the MAC layer (i.e., Layer-2 or data link layer), the network physical driver 332 may establish a MAC connection, generally shown as 340 and 350, for each VMs 310 and 320, respectively. In particular, the MAC connection 340 may serve as an interface between the VM 310 and the NID 370, and the MAC connection 350 may serve as an interface between the VM 320 and the NID 370. The MAC connections 340 and 350 may be associated with the same wireless network or different wireless networks. In one example, the MAC connection 340 may be associated with a home network whereas the MAC connection 350 may be associated with an office network. In another example, both of the MAC connections 340 and 350 may be associated with the office network but the MAC connection 340 may be associated with a full-time employee profile whereas the MAC connection 350 may be associated with a guest profile. Also, the MAC connections 340 and 350 may be use the same wireless communication channel or different wireless communication channels.

The network physical driver 332 may be operatively coupled to a MAC coordination device 360. In general, the MAC coordination device 360 may coordinate sharing of one or more resources of the wireless communication platform 300 by the VMs 310 and 320 (e.g., common hardware and/or radio resources) so that the VMs 310 and 320 may operate simultaneously and/or concurrently via the MAC connections 340 and 350, respectively.

The MAC coordination device 360 may be operatively coupled to a network interface device (NID) 370. The wireless communication platform 300 may use the NID 370 to communicate with one or more wireless communication networks. For example, the NID 370 may be a network interface card. As a result, the network physical driver 332 and the MAC coordination device 360 may emulate the NID 370 for each of the VMs 310 and 320 to provide an independent and transparent connection to a wireless communication network (e.g., the WLAN 200 of FIG. 2). The methods and apparatus described herein are not limited in this regard.

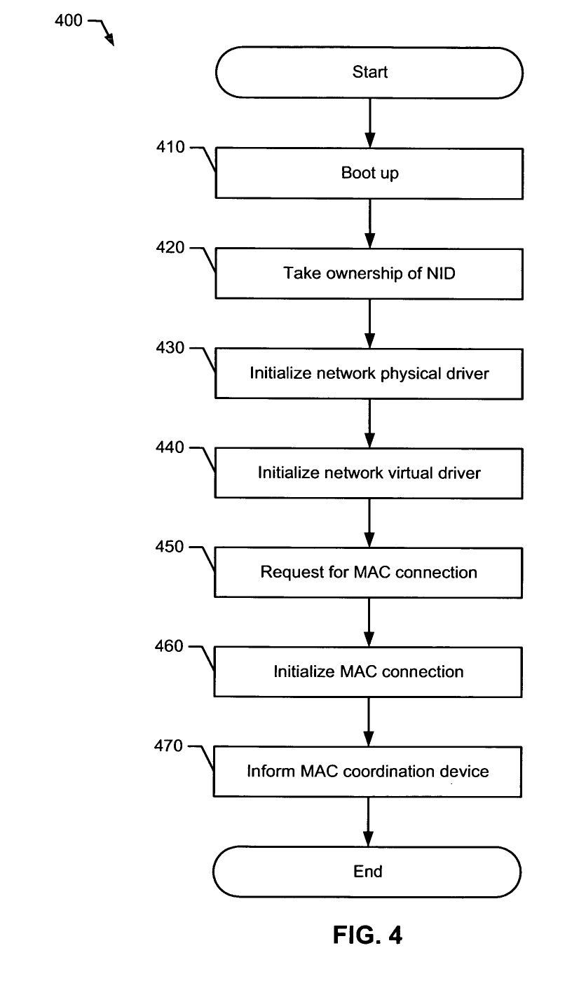

FIGS. 4, 5, and 6 depict one manner in which a wireless communication platform may be configured to provide a virtualization system for multiple MAC connections. The example processes 400, 500, and 600 of FIGS. 4, 5, and 6, respectively, may be implemented as machine-accessible instructions utilizing any of many different programming codes stored on any combination of machine-accessible media such as a volatile or non-volatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium.

Further, although a particular order of actions is illustrated in each of FIGS. 4, 5, and 6, these actions may be performed in other temporal sequences (e.g., simultaneously or concurrently). Again, the example processes 400, 500, and 600 are merely provided and described in conjunction with the wireless communication platform of FIG. 3 as an example of one way to provide a virtualization system for multiple MAC connections.

In the example of FIG. 4, the process 400 may begin with the wireless communication platform 300 booting up to implement multiple MAC connections via a single NID (e.g., the NID 370 of FIG. 3) (block 410). Each MAC connection may be used independently by a corresponding OS. In one example, the OS 312 may use the MAC connection 340 independent of the OS 322, and the OS 322 may use the MAC connection 350 independent of the OS 312. The network virtualization partition 330 may take ownership of the NID 370 (block 420). The NID 370 may be shared by two or more MAC connections associated with the VMs 310 and 320 of the wireless communication platform 300. The network virtualization partition 330 may also initialize the network physical driver 332 (block 430). As noted above the network physical driver 332 may operate as an interface between the NID 370 and the network virtual drivers 318 and 328 of the VMs 310 and 320, respectively.

The VMs 310 and 320 may initialize the corresponding network virtual drivers 318 and 328, respectively (block 440). The network virtual drivers 318 and 328 may emulate the network physical driver 332 for the OS 312 and 322, respectively. Each of the network virtual drivers 318 and 328 may request for a MAC connection (block 450). Accordingly, the network physical driver 332 may initialize one or more MAC connections (block 460). In one example, the network physical driver 332 may initialize the MAC connection 340 for the network virtual driver 318, and the MAC connection 350 for the network virtual driver 328. The network physical driver 332 may inform the MAC coordination device 360 of the initialized MAC connections 340 and 350 (block 470). As described in detail below, the MAC coordination device 360 may coordinate the sharing of resources between the MAC connections 340 and 350. The methods and apparatus described herein are not limited in this regard.

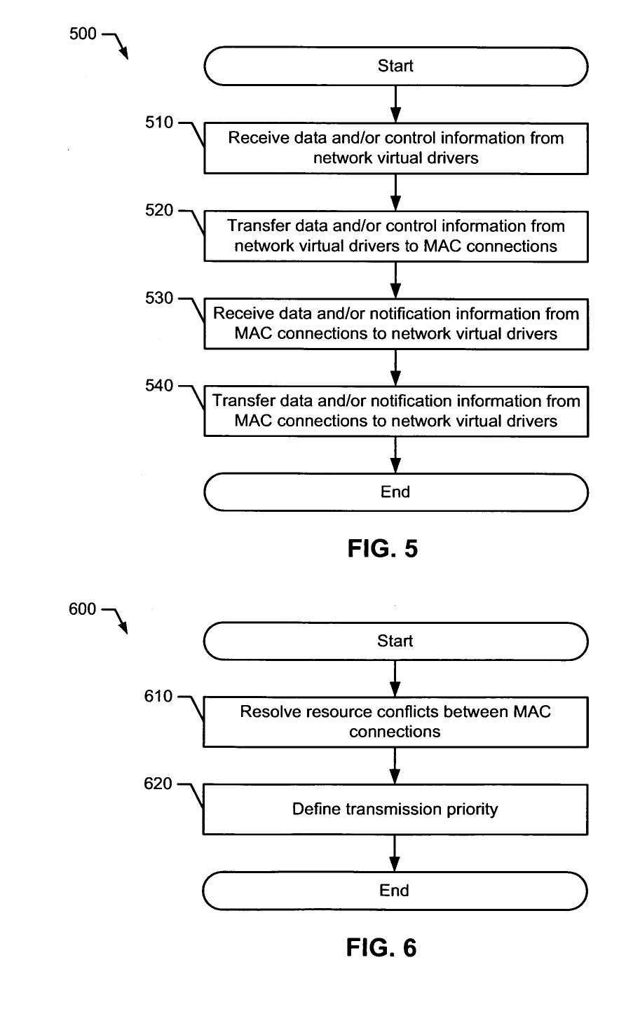

The network physical driver 332 may communicate information between a network virtual driver and a corresponding MAC connection of the wireless communication platform 300. In one example, the network physical driver 332 may communicate information between the network virtual driver 318 and the MAC connection 340. In a similar manner, the network physical driver 332 may communicate information between the network virtual driver 328 and the MAC connection 350. Turning to FIG. 5, for example, the process 500 may begin with the network physical driver 332 receiving data and/or control information from one or more of the network virtual driver(s) 318 and/or 328 (block 510). The network physical driver 332 may transfer the data and/or control information to the corresponding MAC connections 340 and/or 350 (block 520). In one example, the network physical driver 332 may transmit data and/or control information from the network virtual driver 318 to the MAC connection 340. In another example, the network physical driver 332 may transmit data and control information from the network virtual driver 328 to the MAC connection 350.

The network physical driver 332 may also receive data and/or notification information from one or more of the MAC connections 340 and/or 350 (block 530). Accordingly, the network physical driver 332 may transfer the data and/or notification information to the corresponding network virtual drivers 318 and/or 328 (block 540). In one example, the network physical driver 332 may transfer data and/or notification information from the MAC connection 340 to the network virtual driver 318. In another example, the network physical driver 332 may transfer data and/or notification information from the MAC connection 350 to the network virtual driver 328. The methods and apparatus described herein are not limited in this regard.

In the example of FIG. 6, the process 600 may begin with the MAC coordination device 360 resolving one or more conflicts between the MAC connections 340 and 350 (block 610). The MAC coordination device 360 coordinate between the MAC connections 340 and 350 based on media access mechanisms in accordance with various standards developed by IEEE, and/or other special interest groups and standard development organizations. For example, the IEEE 802.11 family of standards and/or variations and evolutions of these standards (e.g., the IEEE std. 802.11e-2005 (published Nov. 11, 2005)) may enhance QoS of the MAC layer by defining media access mechanisms such as power save polling, network allocation vector (NAV), request to send (RTS)/clear to send (CTS), automatic power save delivery (APSD), etc. In particular, the MAC coordination device 360 may assign a time period when the NID 370 is available to a particular MAC connection. In one example, the MAC coordination device 360 may allocate a first time period for the NID 370 to be available to the MAC connection 340, and a second time period for the NID 370 to be available to the MAC connection 350. In another example, the MAC connections may share an identical wireless communication channel. Accordingly, the MAC coordination device 360 may arrange the packet transmission requests from the MAC connections 340 and 350 in a serial manner. The MAC coordination device 360 may also arrange write requests for write access to a register (not shown) in a serial manner. The methods and apparatus described herein are not limited in this regard.

Accordingly, the MAC coordination device 360 may define transmission priority between the MAC connections 340 and 350 (block 620). The MAC coordination device 360 may support multiple MAC connections simultaneously or concurrently by coordinating resources of the wireless communication platform 300 such as the NID 370 between the MAC connections 340 and 350. As a result, each operating system of the VMs 310 and 320 may operate the corresponding MAC connection independently. The methods and apparatus described herein are not limited in this regard.

Although the above examples are described with respect to WLANs, the methods and apparatus described herein may be implemented in other suitable types of wireless communication networks such as WMANs and/or WWANs.

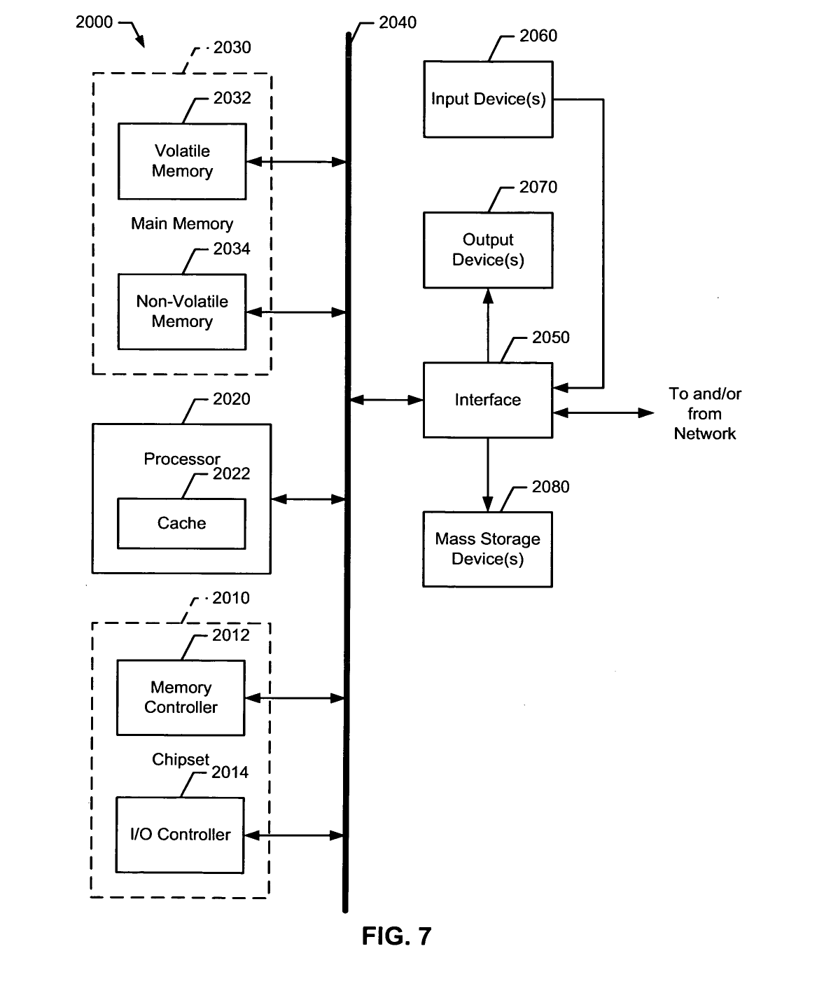

FIG. 7 is a block diagram of an example processor system 2000 adapted to implement the methods and apparatus disclosed herein. The processor system 2000 may be a desktop computer, a laptop computer, a handheld computer, a tablet computer, a personal digital assistant (PDA), a server, an Internet appliance, and/or any other type of computing device.

The processor system 2000 illustrated in FIG. 7 may include a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WPAN components, WLAN components, WMAN components, WWAN components, and/or other suitable processing components. For example, the processor 2020 may be implemented using one or more of the Intel® Core™ technology, Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by synchronous dynamic random access memory (SDRAM), dynamic random access memory (DRAM), RAMBUS dynamic random access memory (RDRAM), static random access memory (SRAM) and/or any other type of random access memory device. The non-volatile memory 2034 may be implemented by flash memory, read only memory (ROM), electrically erasable programmable read only memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the 1,0 controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 7 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
initializing a plurality of media access control (MAC) connections at a network physical driver of a wireless communication platform having a plurality of virtual machines, each of the plurality of MAC connections being associated with one of the plurality of virtual machines; and
coordinating one or more shared resources of the wireless communication platform between the plurality of MAC connections at a MAC coordination device, the MAC coordination device being operatively coupled to the network physical driver and a network interface device of the wireless communication platform.

2. A method as defined in claim 1, wherein coordinating the one or more shared resources of the wireless communication platform between the plurality of MAC connections comprises resolving resource conflicts between the plurality of MAC connections based on a media access mechanism.

3. A method as defined in claim 1, wherein coordinating the one or more shared resources of the wireless communication platform between the plurality of MAC connections comprises defining priority of transmission via the network interface device between the plurality of MAC connections.

4. A method as defined in claim 1 further comprising receiving at least one of data information or control information from a network virtual driver of one of the plurality of virtual machines at the network physical driver, and transferring the at least one of data information or control information to one of the plurality of MAC connections associated with the one of the plurality of virtual machines.

5. A method as defined in claim 1 further comprising receiving at least one of data information or notification information from one of the plurality of MAC connections at the network physical driver, and transferring the at least one of data information or notification information to a network virtual driver of one of the plurality of MAC connections associated with the one of the plurality of MAC connections.

6. A method as defined in claim 1, wherein a first virtual machine of the plurality of virtual machines comprises a first profile and a first supplicant, and a second virtual machine of the plurality of virtual machines comprises a second profile and a second supplicant.

7. A method as defined in claim 1, wherein the wireless communication platform is associated with a wireless local area network.

8. An article of manufacture including content, which when accessed, causes a machine to:
initialize a plurality of media access control (MAC) connections at a network physical driver of a wireless communication platform having a plurality of virtual machines, each of the plurality of MAC connections being associated with a network virtual driver of one of the plurality of virtual machines; and
coordinate one or more shared resources of the wireless communication platform between the plurality of MAC connections at a MAC coordination device, the MAC coordination device being operatively coupled to the network physical driver and a network interface device of the wireless communication platform.

9. An article of manufacture as defined in claim 8, wherein the content, when accessed, causes the machine to coordinate the one or more shared resources of the wireless communication platform between the plurality of MAC connections by resolving resource conflicts between the plurality of MAC connections based on a media access mechanism.

10. An article of manufacture as defined in claim 8, wherein the content, when accessed, causes the machine to coordinate the one or more shared resources of the wireless communication platform between the plurality of MAC connections by defining priority of transmission via the network interface device between the plurality of MAC connections.

11. An article of manufacture as defined in claim 8, wherein the content, when accessed, causes the machine to receive at least one of data information or control information from a network virtual driver of one of the plurality of virtual machines at the network physical driver, and transfer the at least one of data information or control information to one of the plurality of MAC connections associated with the one of the plurality of virtual machines.

12. An article of manufacture as defined in claim 8, wherein the content, when accessed, causes the machine to receive at least one of data information or notification information from one of the plurality of MAC connections at the network physical driver, and transfer the at least one of data information or notification information to a network virtual driver of one of the plurality of MAC connections associated with the one of the plurality of MAC connections.

13. An article of manufacture as defined in claim 8, wherein a first virtual machine of the plurality of virtual machines comprises a first profile and a first supplicant, and a second virtual machine of the plurality of virtual machines comprises a second profile and a second supplicant.

14. An article of manufacture as defined in claim 8, wherein the wireless communication platform is associated with a wireless local area network.

15. An apparatus comprising:
a network physical driver to initialize a plurality of media access control (MAC) connections of a wireless communication platform having a plurality of virtual machines, each of the plurality of MAC connections being associated with a network virtual driver of one of the plurality of virtual machines;
a media access control (MAC) coordination device operatively coupled to the network physical driver to coordinate one or more shared resources of the wireless communication platform between the plurality of MAC connections; and
a network interface device operatively coupled to the MAC coordination device.

16. An apparatus as defined in claim 15, wherein the MAC coordination device is configured to resolve resource conflicts between the plurality of MAC connections based on a media access mechanism.

17. An apparatus as defined in claim 15, wherein the MAC coordination device is configured to define priority of transmission via the network interface device between the plurality of MAC connections.

18. An apparatus as defined in claim 15, wherein the network physical driver is configured to receive at least one of data information or control information from a network virtual driver of one of the plurality of virtual machines, and to transfer the at least one of data information or control information to one of the plurality of MAC connections associated with the one of the plurality of virtual machines.

19. An apparatus as defined in claim 15, wherein the network physical driver is configured to receive at least one of data information or notification information from one of the plurality of MAC connections, and to transfer the at least one of data information or notification information to a network virtual driver of one of the plurality of MAC connections associated with the one of the plurality of MAC connections.

20. An apparatus as defined in claim 15, wherein a first virtual machine of the plurality of virtual machines comprises a first profile and a first supplicant, and a second virtual machine of the plurality of virtual machines comprises a second profile and a second supplicant.

21. An apparatus as defined in claim 15, wherein the wireless communication platform is associated with a wireless local area network.

22. A system comprising:
an omni-directional antenna; and
a processor operatively coupled to the antenna to initialize a plurality of media access control (MAC) connections at a network physical driver of a wireless communication platform having a plurality of virtual machines, and to coordinate one or more shared resources of the wireless communication platform between the plurality of MAC connections at a MAC coordination device,
wherein each of the plurality of MAC connections is associated with a network virtual driver of one of the plurality of virtual machines, and
wherein the MAC coordination device is operatively coupled to the network physical driver and a network interface device of the wireless communication platform.

23. A system as defined in claim 22, wherein the processor is configured to resolve resource conflicts between the plurality of MAC connections based on a media access mechanism.

24. A system as defined in claim 22, wherein the processor is configured to define priority of transmission via the network interface device between the plurality of MAC connections.

25. A system as defined in claim 22, wherein the processor is configured to receive at least one of data information or control information from a network virtual driver of one of the plurality of virtual machines, and to transfer the at least one of data information or control information to one of the plurality of MAC connections associated with the one of the plurality of virtual machines.

26. A system as defined in claim 22, wherein the processor is configured to receive at least one of data information or notification information from one of the plurality of MAC connections, and to transfer the at least one of data information or notification information to a network virtual driver of one of the plurality of MAC connections associated with the one of the plurality of MAC connections.

27. A system as defined in claim 22, wherein a first virtual machine of the plurality of virtual machines comprises a first profile and a first supplicant, and a second virtual machine of the plurality of virtual machines comprises a second profile and a second supplicant.

28. A system as defined in claim 22, wherein the wireless communication platform is associated with a wireless local area network.
